(19) United States
(12) Patent Application Publication
(10) Pub. No.: US 2026/0271151 A1
(43) Pub. Date: Sep. 10, 2026

(54) DEVICE FOR DISTRIBUTING LIGHT IN A BUILDING BLOCK MODEL

(71) Applicant: DOUBLEEAGLE INDUSTRY (CHINA) LIMITED, Shantou City (CN)

(72) Inventor: Dunhua Yang, Shenzhen (CN)

(21) Appl. No.: 19/536,051

(22) Filed: Feb. 10, 2026

(30) Foreign Application Priority Data
Mar. 5, 2025 (CN) 202510257627.3

(51) Int. Cl. H05B 45/20; H05B 47/19

(52) U.S. Cl. CPC H05B 45/20; H05B 47/19

(57) ABSTRACT

A device for distributing light in a building block model includes: a first light source and a second light source, a control circuit for controlling an operating state of the first light source and an operating state of the second light source, a housing enclosing the control circuit and the light sources, with a first connection interface for holding a first end of a first optical fiber in a position where the first optical fiber can receive light emitted by the first light source at its first end and guide it to its second end, and with a second connection interface for holding a first end of a second optical fiber in a position where the second optical fiber can receive light emitted by the second light source at its first end and guide it to its second end.

### TECHNICAL FIELD

The invention relates to a device for distributing light in a building block model.

### BACKGROUND

For illuminating a building block model, electrical energy is transported by directing current via thin cables or conductive tracks to the illumination points within the model. On-site, light is generated using suitable converters, such as light bulbs, LEDs, or similar technologies. For example, DE 100 24 648 A1 discloses that electrical energy can also be transmitted wirelessly via induction, although the conversion of electrical energy into light still takes place directly at the illumination points.

### SUMMARY

The objective of the invention is to improve the lighting in a building block model.

This objective is achieved through the features of the independent claim. Preferred embodiments are the subject of the dependent claims.

According to one aspect of the invention, a device for distributing light in a building block model includes a first light source and a second light source, a control circuit for controlling an operating state of the first light source and an operating state of the second light source, a housing enclosing the control circuit and the light sources, a first connection interface for holding a first end of a first optical fiber in a position where the first optical fiber can receive light emitted from the first light source with its first end and guide it to its second end, and a second connection interface for holding a first end of a second optical fiber in a position where the second optical fiber can receive light emitted from the second light source with its first end and guide it to its second end.

In contrast to the previously mentioned method of illumination, the proposed device suggests converting electrical energy into light no longer directly at the illumination points in the model but centrally at an energy distribution point. This involves positioning the light sources at the energy distribution point and transporting the generated light from there to the individual illumination points in the model using optical fibers.

This proposal is based on the idea of relocating the light generation process from the often hard-to-reach and spatially limited illumination points to a central location. This makes it possible to effectively concentrate the light and flexibly and efficiently transport it to the desired locations via optical fibers. This approach not only overcomes technical limitations of the previous method but also opens up new design possibilities.

Since optical fibers are used instead of electrical wiring to transport the light to the illumination points, the need for delicate cables to carry electrical energy to these points is eliminated. Optical fibers are more robust and resistant to mechanical stresses, significantly simplifying the construction. This not only reduces wiring complexity but also minimizes the risk of cable breakage or connection issues. As a result, the lighting solution becomes more durable and reliable.

By relocating the light sources to a central energy distribution point, LEDs or other light sources are no longer needed at the illumination points. This frees up additional space, which is particularly advantageous in small models where the limited space can be fully utilized for model construction.

Moreover, in complex models, defective light sources no longer need to be replaced in hard-to-reach or confined areas of the model. Instead, they can be serviced or replaced centrally in the device, greatly simplifying the repair and maintenance of the model.

In an advanced embodiment of the specified device, the control circuit includes a first control element for the individual control of the first light source, a second control element for the individual control of the second light source, and a third control element for the simultaneous control of the first and second light sources. By enabling individual control of the light sources, various illumination points in the model can be independently supplied with light of different intensities, colors, or effects. This increases flexibility and allows lighting scenarios to be precisely tailored to the requirements of the model. At the same time, the third control element enables the synchronized control of both light sources, allowing a predefined but still individually adjustable lighting state to be implemented, for example, when the lights are switched on. The combination of individual and collective control blends creativity with efficiency, opening up diverse design possibilities without complicating usability.

In a specific embodiment of the device, the third control element includes a switch for jointly adjusting the operating states of the first and second light sources. This design allows different lighting states to be realized through simple sequential button codes. For instance, a single button press can toggle the light sources on or off, while repeated or longer button presses can modify brightness, blinking patterns, or color modulations. This enables intuitive operation, as complex controls can be implemented through straightforward interaction with the switch. Users are thus provided with a flexible and straightforward way to create various lighting effects without requiring additional control devices or complex programming. This significantly simplifies the operation of lighting, particularly in compact and intricately detailed building block models, while still offering a broad spectrum of lighting effects.

In another embodiment, the specified device includes a data transmission interface configured to receive an individual control instruction for adjusting the operating state of the first light source and relay it to the first control element, as well as to receive an individual control instruction for adjusting the operating state of the second light source and relay it to the second control element. This data transmission interface enables more complex control interfaces to be transferred to already available resources, such as computers, mobile phones, or tablets. By utilizing such devices, the control of the light sources can be achieved through intuitive and user-friendly interfaces, such as apps or software applications. These not only allow precise control of lighting parameters such as brightness, colors, or blinking patterns but also enable the creation and management of complex lighting scenarios. This approach minimizes the need for physical switches or controls on the device, reducing its overall size and broadening its range of applications. Simultaneously, users can leverage the functionality and convenience of their existing devices without needing to integrate additional control units or displays into the system.

In a preferred embodiment of the specified device, the data transmission interface is configured to wirelessly receive control instructions, preferably using a Bluetooth protocol. The use of a wireless data transmission interface offers numerous advantages in addition to reducing cabling requirements. It provides greater flexibility in placement, as the device can operate independently of the control unit's location. Furthermore, the extended range simplifies control, allowing the model to be managed from a distance without requiring physical connections. Bluetooth, as a standard protocol, also ensures high compatibility with existing devices such as smartphones or tablets, eliminating the need for additional control hardware. The absence of physical interfaces also reduces the device's size and minimizes the risk of mechanical failures, such as cable breakage or short circuits caused by contamination. Additionally, wireless communication significantly simplifies retrofitting into existing models, as no cables need to be routed through the model.

In another embodiment, the specified device includes a memory for storing the configured operating states of the first and second light sources, which should preferably be non-volatile. Integrating a memory to store the configured operating states of the first and second light sources, especially when the memory is non-volatile, offers several advantages. A key benefit is that lighting settings are retained even after the device is powered off or experiences a power interruption. This eliminates the need to reconfigure the preferred operating states upon every restart, significantly enhancing user convenience. Another advantage is the ability to permanently save individual or complex lighting scenarios. This is particularly useful when the model is used regularly and requires different lighting modes for various occasions or presentations. The non-volatile memory enables these scenarios to be saved permanently and quickly recalled when needed. Additionally, this memory improves robustness against short-term interruptions, such as loose connections or accidental disconnection of the power supply. After power is restored, the lighting automatically resumes its previous configuration without requiring manual intervention.

In a further embodiment of the specified device, each connection interface is designed as a sleeve extending through the housing. The sleeve is open at a front side facing the exterior of the housing to receive the respective optical fiber and is arranged with its base above the corresponding light source. While other mechanisms such as spring-based clamping systems, screw connections, or elastic membranes could be used for fixing the optical fibers, sleeves are particularly advantageous as they ensure precise and stable positioning of the optical fiber relative to the light source. The firm guidance provided by the sleeve ensures that the optical fiber is optimally aligned with the light source, maximizing the efficiency of light coupling. Additionally, the sleeve protects the optical fiber mechanically from external influences such as tensile or compressive forces and offers a simple, robust, and low-maintenance construction. These characteristics make the sleeve a functional and reliable solution, particularly suitable for applications requiring high precision and mechanical stability.

In an additional embodiment of the specified device, the base of each sleeve is sealed with a transparent material. This seal effectively protects the respective light source from external influences such as dust, dirt, or moisture that could enter the housing and impair the functionality or lifespan of the light source. At the same time, light transmission is ensured, as the transparent material allows light to pass through with minimal loss. Another advantage of this seal is protection against mechanical damage. The sensitive light source is shielded by the closed sleeve, which is particularly beneficial in cases of vibrations or impacts, such as those occurring in mobile applications like vehicle models, or simply to prevent the optical fiber from being inserted too deeply. Additionally, the seal helps to minimize stray light within the housing, further enhancing the efficiency of light coupling into the optical fiber. This protective feature makes the device more durable, maintenance-friendly, and reliable in operation.

In a particularly preferred embodiment of the specified device, an inner surface of the sleeve?s mantle, which connects the front side to the base, is equipped with linear friction elements. These elements enable the optical fiber inserted into the respective sleeve to be securely held in and against the direction of insertion through friction. When the optical fiber is inserted, the linear friction elements provide controlled guidance, stabilizing the fiber and preventing lateral displacement. This facilitates the precise insertion of the optical fiber into the sleeve, ensuring it is quickly and accurately positioned. During operation, the frictional hold ensures that the optical fiber remains securely in place within the sleeve without the need for additional fastening elements such as screws or clamps. The linear friction elements create uniform holding force along the mantle surface, allowing the optical fiber to remain securely in position even during vibrations or light tensile forces. The design also simplifies removal, as the optical fiber can be pulled out by overcoming the frictional resistance without damaging the mantle. This simplifies handling and facilitates system maintenance. Overall, this embodiment combines precision, stability, and user-friendliness in an efficient manner.

According to another aspect of the invention, a building block model comprises a plurality of building blocks that can be assembled into a complete structure, one of the specified devices that can be integrated into the complete structure, a first optical fiber for transporting light from the first connection interface to a first location in the complete structure, and a second optical fiber for transporting light from the second connection interface to a second location in the complete structure.

### BRIEF DESCRIPTION OF FIGURES

The above-described characteristics, features, and advantages of this invention, as well as the manner in which they are achieved, are further illustrated in the following description of exemplary embodiments, which are explained in more detail in conjunction with the drawings. The drawings show:

FIG. 1: A view of a partially assembled building block model,

FIG. 2: A view of a device for distributing light in the building block model of FIG. 1,

FIG. 3: An enlarged view of a section of the device shown in FIG. 2,

FIG. 4: A view of the device shown in FIG. 2 in an open state, and

FIG. 5: A structural representation of the device shown in FIG. 2 with a remote control for operating the device.

In the figures, identical technical elements are denoted with the same reference numerals and are described only once. The figures are purely schematic and do not represent actual geometric proportions.

### DETAILED DESCRIPTION

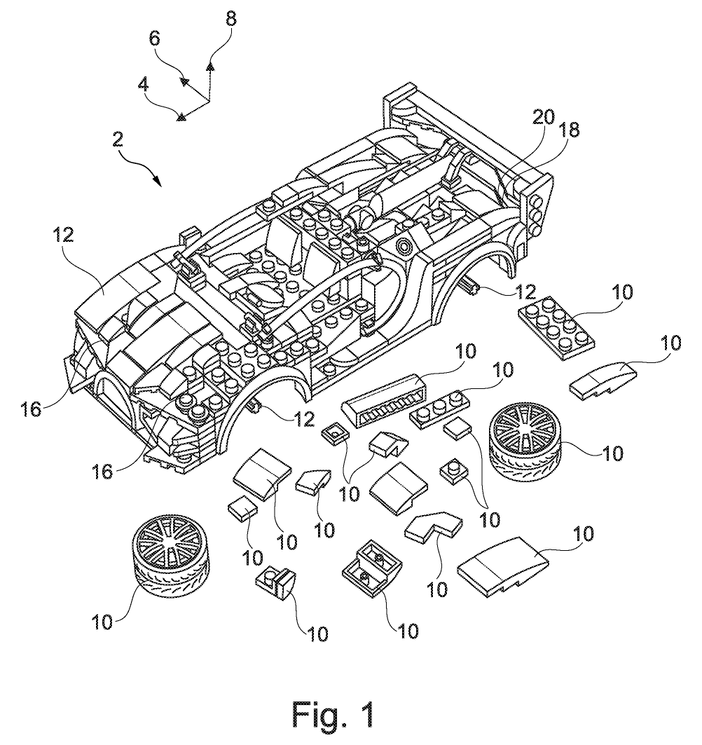

Reference is made to FIG. 1, which shows a view of a partially assembled building block model 2.

The building block model 2 is designed in this embodiment as a vehicle movable along a longitudinal direction 4. The vehicle extends in the longitudinal direction 4, a transverse direction 6 perpendicular to the longitudinal direction 4, and a height direction 8 perpendicular to both the longitudinal direction 4 and the transverse direction 6.

The depicted vehicle is constructed from a multitude of building blocks 10, which, for clarity, are not all labeled with reference numerals in FIG. 1. Each building block 10 is a reusable component for the modular and scalable construction of the building block model 2. Each building block 10 follows a standardized grid size, ensuring that building blocks 10 of different sizes and shapes can seamlessly connect to one another. The connection is achieved through a mechanical clamping principle, where protrusions such as studs or pins on one building block 10 are pressed into corresponding recesses on another building block, both of which are not further referenced in FIG. 1. This results in a stable but detachable connection. This modular design allows for virtually unlimited combinations, enabling the building blocks 10 to be flexibly assembled, disassembled, and reused.

The vehicle shown in FIG. 1 is used purely as an illustrative example of the building block model 2 and is therefore only briefly explained in its construction. It includes a chassis 12 that is supported by wheels for mobility. The corresponding wheel axles 14 are visible in the assembly state shown in FIG. 1; the wheels still need to be mounted onto these axles. At the front side of the building block model 2, seen in the longitudinal direction 4, transparent blocks can be observed. These are used as headlights 16 in the completed state. Later, an optical fiber will be connected to these transparent blocks from the rear side, as seen in the longitudinal direction 4, in a manner to be described later, to illuminate the headlights 16. Similarly, at the rear side of the building block model 2, seen in the longitudinal direction 4, transparent blocks are present. These are used as taillights 18 and brake lights 20 in the completed state. Optical fibers will also be attached to these transparent blocks from the front, as seen in the longitudinal direction 4, in a manner to be described later, to illuminate the respective taillights 18 or brake lights 20.

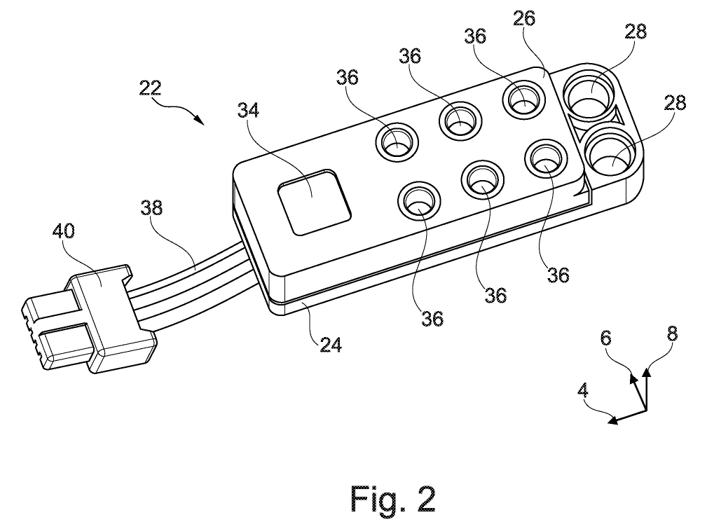

In this embodiment, the illumination is generated centrally and then, as previously mentioned, distributed to the individual building blocks to be illuminated via optical fibers. For this purpose, a central device 22 is used, which will first be explained in more detail with reference to FIG. 2.

The device 22 has a primarily cuboidal design and, for simplicity, is assumed to be oriented with its longitudinal side aligned with the longitudinal direction 4 in the already defined coordinate system. However, it can be placed anywhere in the building block model 2.

The device 22 consists of a housing made up of a lower shell 24 and an upper shell 26 mounted on the lower shell 24 against the height direction 8. At the rear side, seen in the longitudinal direction 4, the lower shell 24 is traversed by two axle supports 28 arranged according to the aforementioned standardized grid size in the height direction. These supports allow the device 22 to be fixed at a specific location within the building block model.

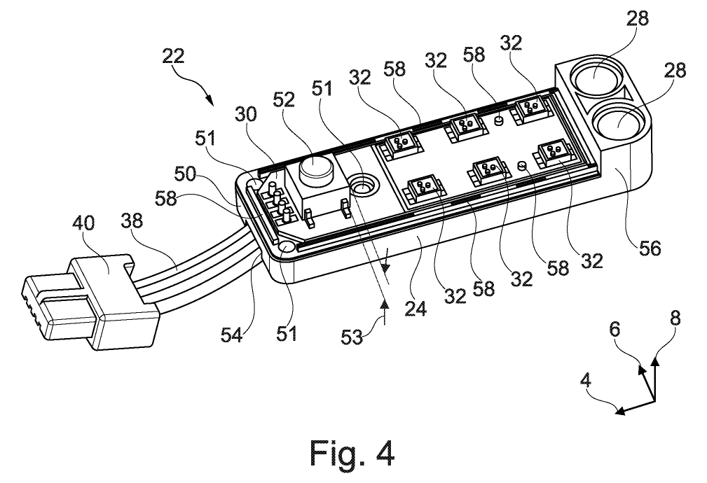

On the lower shell 24, a circuit board 30 with light sources 32 at predefined positions is mounted, as shown in FIG. 4. These predefined positions are relevant for the further explanation of FIG. 2. Further details on the circuit board 30 will be provided later.

The upper shell 26, which is thus mounted on the circuit board 30, is traversed by several passage openings, which are not further referenced, through which functional elements of the device 22 are guided.

One of these functional elements is an operating button 34, which can be used to set an operating state of the device 22 in a manner to be described later. The other functional elements are transparent sleeves 36, which, in the state where the upper shell 26 is mounted on the lower shell 24, are placed at the previously mentioned predefined positions. This ensures that, as seen in the height direction 8, each transparent sleeve 36 covers the respective light source 32 in both the longitudinal direction 4 and the transverse direction 6.

Finally, a supply cable 38 connected to the circuit board 30 is guided through the lower shell. At the end opposite the circuit board, a connector 40 is attached. The connector can be designed in any manner but follows the structure known from DE 102022114167 B3 in the present embodiment. The supply cable enables the circuit board 30 to be supplied with electrical energy and/or data signals.

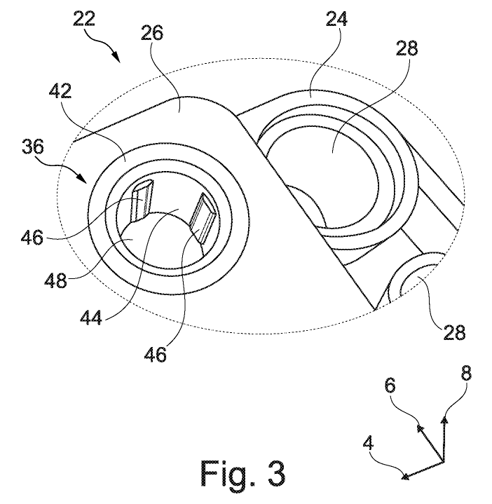

Transparent sleeves 36 are explained in more detail with reference to FIG. 3.

In principle, the sleeves 36 can be manufactured as a single unit with the upper shell 26, for example, using injection molding. However, in this case, the entire upper shell 26 would need to be made from a uniform material that meets the technical requirements, particularly regarding the transparency of the material.

For this reason, in the present embodiment, the sleeves 36 are inserted into passage openings in the upper shell 26, which are not further depicted in the figures. To secure the sleeves, they have a flange 42 on their upper side, as seen in the height direction 8. This flange provides a contact surface with the upper shell 26, where each sleeve 36 can be secured to the upper shell 26, for example, using adhesive.

From the flange 42, a cylindrical mantle 44 extends into the interior of the upper shell against the height direction 8. Linear friction elements 46 are formed on the radially inward-facing surfaces of the mantle. These friction elements extend axially in the height direction and are distributed circumferentially on the mantle with a spacing of less than 180°, ensuring that the optical fiber is pressed against all linear friction elements 46 when inserted into the sleeve 36 and is thereby securely held.

To prevent the optical fiber from being inserted too deeply against the height direction 8 into the sleeve 36, potentially damaging the light source 32 below, the sleeves 36 have an axial stop element on their side opposite the flange 42 in the height direction 8. This stop element can, for example, be a radially inward-facing flange. In the present embodiment, the stop element is a closing bottom 48 for the sleeve, protecting the light sources 32 not only from excessive insertion of the optical fiber but also from external contaminants such as dust.

The following focuses on the lower shell 24 depicted in FIG. 4, which supports the circuit board 30.

The lower shell 24 features a base foot 50, which has three through-holes 51 in the height direction 8 on its front side, as seen in the longitudinal direction 4, and slightly recessed in the longitudinal direction 4. These through-holes allow fastening elements, such as screws, to connect the upper shell 26 to the lower shell 24. Between these three through-holes 51, a button 52 is positioned to register a downward force against the height direction 8 on the operating button 34 and convert this force into an electrical signal. Further details about this will be explained later. The button 52 contains an unspecified button component housed within an unspecified button body, which is guided transversely to the height direction 8 and equipped with a return mechanism. This is a known design and does not require further elaboration. However, the button body has a height 53 specifically calibrated to an unspecified height of the upper shell 26. When the upper shell 26 is placed on the lower shell 24, the upper shell 26 mechanically contacts the button body, thereby pressing the circuit board 30 against the lower shell 24 in the height direction 8. By placing the through-holes 51 around the button 52, the applied pressure stabilizing the circuit board 30 is further enhanced by fastening elements, such as screws, which act in tension. This ensures secure stability and precise positioning of the lower shell 24, upper shell 26, and circuit board 30.

Between the two through-holes 51 at the front side of the lower shell 24, as seen in the longitudinal direction 4, a groove 54 is formed on the underside of the base foot 50. This groove accommodates the supply cable 38. The groove 54 eventually leads to another through-hole, not visible in FIG. 3, through which the supply cable 38 is routed to the circuit board 30.

On the side of the lower shell 24 opposite the two through-holes 51 in the longitudinal direction 4, the base foot 50 connects to a shoulder stop 56. Through this shoulder stop, the aforementioned axle supports 28 are routed. Additionally, positioning aids 58 in the form of struts and pins are provided on the upper side of the base foot 50, as seen in the height direction 8. These allow the circuit board 30 and the upper shell 26 to be aligned with the lower shell 24, ensuring the previously explained alignment of the sleeves 36 above the light sources 32.

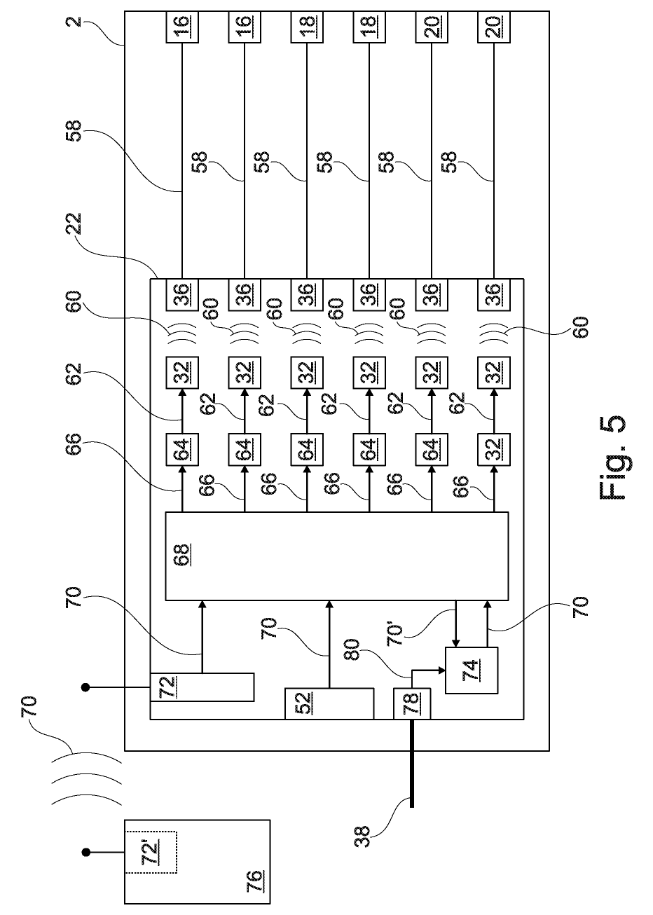

Finally, the operation of the device 22 in the building block model 2 is explained with reference to FIG. 5.

In FIG. 5, the optical fibers are represented as lines between the sleeves 36 and the lighting elements 16, 18, 20 in the building block model 2, and they are labeled with reference number 58. The light emitted by the light sources 32 through the sleeves 36 to the optical fibers 58 is designated by reference number 60.

To generate the light 60, each light source 32 is controlled by an individual light source control signal 62, which is output by an individual light controller 64 for each light source 32. The individual light controllers 64 receive individual control instructions 66 from a central control unit 68 to generate their respective light source control signals 62. The control instructions 66 can take various forms, such as commands like "blink," "brightness X," or "color Y." Each individual light controller 64 decodes these commands and generates an appropriate individual control signal 62 to execute the command with its associated light source 32. For example, if the light sources are implemented as color-controllable diodes, the command "blink" could be executed using a pulsed on-and-off control signal 62. The command "brightness X" could be implemented by adjusting the signal strength of the control signal 62, while the command "color Y" could be realized with a multidimensional control signal 62, where each component corresponds to a color to be mixed to achieve the desired target color, and its intensity is also adjusted.

The central control unit 68 generates the control instructions 66 based on configuration data 70, which originates from a network interface 72, the button 52, or a memory 74. These configuration data 70 must be formatted such that the central control unit 68 can address the desired light source 32 and generate the necessary command for it.

An easy way to provide the configuration data 70 is through a remote control 76 with an interface analogous to the network interface 72. A suitable remote control 76 could be a smartphone equipped with a Bluetooth module as its network interface 72', running a control application. This application, operated by the user, generates the configuration data 70 and transmits them wirelessly via Bluetooth to the network interface 72 of the device 22. The practical implementation of such an application is left to the developer's discretion and does not require further elaboration here.

Alternatively, the user can generate the configuration data 70 using the button 52. This can be achieved through a predefined sequence of button presses. For example, a short button press could set the control box into a mode where it generates configuration data 70 based on the button 52. In this mode, all light sources 32 might produce a predefined lighting effect, which will be explained later. Another short press could switch all light sources 32 to constant white light. Subsequent short presses could alternate the color of all light sources 32, cycling through red, green, yellow, and blue. A final short press could switch off the control box.

In this case, the central control unit 68 addresses all individual light controllers 64 with the same control instruction 66. This approach is practical because directly controlling individual light sources 32 using the button 52 could overwhelm an average user.

When configuration data 70 are received and converted into control instructions 66, they can also be saved as backup data 70' in memory 74. If the power supply to the device 22 unexpectedly fails, the device 22 can restore its previous state upon restart using the configuration data 70 stored in memory 74.

The button 52 can also be used to set the central control unit 68 to a mode where it accepts configuration data 70 from the network interface 72 instead of the button 52. This can be achieved, for instance, by holding the button down for at least three seconds. In this mode, the central control unit 68 can also save the most recently received configuration data 70 from the network interface 72 as backup data 70' in memory.

In the event of a restart, such as after a power outage, a power supply unit 78 in the device 22 can send an IRQ command 80 to memory 74 to resume the operation of the light sources 32 based on the configuration data 70 stored in memory 74.

For clarity, the control circuits 64 and 68 are shown separately in this embodiment. However, they can easily be integrated into a single microcontroller and do not need to be implemented separately.

What is claimed is:

1. Device (22) for distributing light (60) in a building block model (2), comprising:
a first light source (32) and a second light source (32),
a control circuit (30) for controlling an operating state of the first light source (32) and an operating state of the second light source (32),
a housing (24, 26) enclosing the control circuit (30) and the light sources (32),
with a first connection interface (36) for holding a first end of a first optical fiber (58) in a position where the first optical fiber (58) can receive light (60) emitted by the first light source (32) at its first end and guide it to its second end, and
with a second connection interface (36) for holding a first end of a second optical fiber (58) in a position where the second optical fiber (58) can receive light (60) emitted by the second light source (32) at its first end and guide it to its second end.

2. Device (22) according to claim 1, wherein the control circuit (30) includes:
a first control element (64) for individually controlling the first light source (32),
a second control element (64) for individually controlling the second light source (32), and
a third control element (68) for jointly controlling the first and second light sources.

3. Device (22) according to claim 2, wherein the third control element (68) is connected to a switch (52) for jointly setting the operating states of the first and second light sources (32).

4. Device (22) according to claim 2, comprising a data transmission interface (72), configured to receive an individual control instruction for setting the operating state of the first light source (32) and forward it to the first control element (64), and to receive an individual control instruction for setting the operating state of the second light source (32) and forward it to the second control element (64).

5. Device (22) according to claim 4, wherein the data transmission interface (72) is configured to receive the control instruction wirelessly, preferably using a Bluetooth protocol.

6. Device (22) according to claim 3, comprising a memory (74) for storing the set operating states of the first and second light sources (32), preferably in the form of the most recently executed control instruction.

7. Device (22) according to claim 1, wherein each connection interface (36) is designed as a sleeve passing through the housing (24, 26), open at a front side facing the exterior of the housing to receive the respective optical fiber (58) and arranged with its base above the respective light source (32).

8. Device (22) according to claim 7, wherein the base of each sleeve is sealed with a transparent material.

9. Device (22) according to claim 7, wherein the inner surface of a mantle connecting the front side and the base of each sleeve is equipped with linear friction elements (46), which allow the optical fiber (58) inserted into the respective sleeve to be securely held by friction in and against an insertion direction.

10. Building block model (2), comprising:
a plurality of building blocks (10) that can be assembled into a complete structure,
a device (22) according to claim 1, insertable into the complete structure,
a first optical fiber (58) for transporting light from the first connection interface (36) to a first location within the complete structure, and
a second optical fiber (58) for transporting light from the second connection interface (36) to a second location within the complete structure.

11. Device (22) according to claim 4, comprising a memory (74) for storing the set operating states of the first and second light sources (32), preferably in the form of the most recently executed control instruction.
